(19) United States
(12) Patent Application Publication
(10) Pub. No.: US 2026/0295983 A1
(43) Pub. Date: Oct. 1, 2026

(54) MULTILAYER PACKAGING FILM

(71) Applicant: AMCOR FLEXIBLES NORTH AMERICA, INC., Neenah, WI (US)

(72) Inventors: Jeremy C. REEDY, Appleton, WI (US); Derek J. SAXON, Appleton, WI (US); Kevin P. NELSON, Appleton, WI (US); Lauren A. JUCHT, Omro, WI (US); Steven M. GREY, Oshkosh, WI (US); Daniel C. MILLER, Appleton, WI (US); Justene C. ANDERSON, Appleton, WI (US); Bhushan Hiralal PATIL, Neenah, WI (US); Jingxing Feng, Chicago, IL (US)

(21) Appl. No.: 19/479,302

(22) PCT Filed: Apr. 23, 2024
(86) PCT No.: PCT/US2024/025761

§ 371 Date: Oct. 27, 2025

Related U.S. Application Data
(60) Provisional application No. 63/463,222, filed on May 1, 2023.

(51) Int. Cl. B32B 27/08; B32B 7/12; B32B 27/32; B32B 27/36; B65D 65/40

(52) U.S. Cl. CPC B32B 27/08; B32B 7/12; B32B 27/32; B32B 27/36; B65D 65/40; B32B 2255/10; B32B 2255/26; B32B 2307/72; B32B 2307/7376

(57) ABSTRACT

A multilayer packaging film includes a first film, a second film, a first primer material and a second primer material. The first primer material includes an ionomeric water dispersible material. The second primer material may be selected that includes a melamine-formaldehyde-based water dispersible material, a polyethylenimine (PEI)-based water dispersible material, an iso-cyanate-containing component, and combinations thereof. The first film includes a first polymer and has a first surface and a second surface. The second film includes a second polymer and has a first surface and a second surface. The first primer material and the second primer material are positioned between the first film second surface and the second film first surface.

### TECHNICAL FIELD

This disclosure is related to multilayer packaging films, packaging films, thermoformable films, recyclable films, and rigid packaging components made therefrom. The multilayer packaging films, packaging films, thermoformable films, recyclable films, and rigid packaging components may be recyclable.

### BACKGROUND

Multilayer packaging films and packaging films can be used to form flexible or thermoformed packages. Thermoformed packages include thermoformed containers that are often used as packaging components for consumer, industrial, or medical products. These packages often contain products that are sensitive to their environment (e.g., food, beverages, liquids, pharmaceuticals, etc.) such that the packaging helps protect the product and extend the shelf-life to a point in time where a consumer can use the product.

Common polymers used for flexible packaging and thermoforming include polystyrene (PS), polyvinyl chloride (PVC), polypropylene (PP), or polyester. For some products, some of these polymers provide acceptable barrier for the product contained in the package. For other polymers, such as polyester or PS, the resulting films and packaging components often include additional polymers or additives that are chosen to enhance the moisture barrier or the oxygen barrier of the packaging for the contained product.

Global demand for plastic waste reduction and sustainable packaging solutions is on the rise. For example, packaging films and thermoformed packaging components, such as cups or trays, often cannot be recycled due to the inclusion of a variety of polymers that provide barrier to prevent the ingress of oxygen and/or moisture into the package.

Recycling is often efficient or may only be possible if the materials in the package are of the same polymer type. For example, in many countries, there are current processes in place to collect, sort and recycle packages of a single polymer, for example, polyethylene (PE), polyester, or PP. However, the combination of materials in a packaging film or component (e.g., polyester or PP with additional polymers, additives to enhance barrier, printed layers including ink, etc.) can create difficulties when determining how to dispose of the packaging component after use. Further, some of the current processes in place to recover and recycle packaging components restrict the size and volume of the packaging component. In some recycling processes, a packaging component volume larger than 7.5 liters (2 gallons) or a packaging component size smaller than 5 centimeters (cm) (2 inches (in)) in two dimensions is not acceptable. For example, a packaging component in the form of a liquid creamer cup (e.g., coffee creamer cup, liquid creamer singles, coffee creamer singles) that measures less than 5 cm in each of two dimensions cannot be recycled by most current processes whether it is composed of a single polymer or a combination of polymers.

### SUMMARY

This disclosure relates to multilayer packaging films, packaging films, thermoformable films, recyclable films, and thermoformed components (e.g., packaging component). Thermoformed components may include cups or trays formed from the films. The films and thermoformed components can be used for packaging a wide variety of products including, but not restricted to food, cosmetics, lotions, lawn care products, cleaners/soaps, concentrates, industrial materials, pharmaceuticals, medical supplies, and medical devices. Some films and thermoformed components may not be recyclable due to the thermoformed component size or volume or due to polymer and ink combinations that do not lend themselves to recovery and recycling processes.

The films and thermoformed components of this disclosure include polymer combinations that may be recovered regardless of volume or size, for example, in a wash-sink-float-separation process (e.g., hot wash process, warm water wash process, caustic wash process, alkaline wash process) and further recycled.

In a first aspect, a multilayer packaging film has a first surface and a second surface. The multilayer packaging film comprises a first primer material, an optional second primer material, a first film, and a second film. The first primer material comprises an ionomeric water dispersible material. The optional second primer material is selected from the group comprising a melamine-formaldehyde-based water dispersible material, a polyethylenimine (PEI)-based water dispersible material, an isocyanate-containing component, and combinations thereof. The first film comprises a first polymer and has a first surface and a second surface. The second film comprises a second polymer and has a first surface and a second surface. The first primer material and the second primer material are positioned between the first film second surface and the second film first surface.

In a second aspect, a packaging film has a first surface and a second surface. The packaging film comprises a first primer material, an optional second primer material, a printed layer, and a first film. The first primer material comprises and ionomeric water dispersible material. The optional second primer material selected from the group comprising a melamine-formaldehyde-based water dispersible material, a polyethylenimine (PEI)-based water dispersible material, an isocyanate-containing component, and combinations thereof. The printed layer comprises an ink selected from the group comprising a polyvinyl butyral (PVB)-based ink, a polyurethane (PU)-based ink, a nitrocellulose-based ink, a polyamide-based ink, a polyester-based ink, and an acrylate-based ink. The first film comprises a first polymer and has a first surface and a second surface. The first primer material and the second primer material are positioned between the first film second surface and the printed layer.

Other aspects that may be used individually or in combination with respect to the first aspect are as follows.

In some aspects, the second polymer may comprise a material selected from the group comprising polyethylene and polyethylene copolymers.

In some aspects, the second film second surface may comprise the multilayer packaging film second surface.

In some aspects, the multilayer packaging film may further comprise an average bond strength of 20 grams/25.4 millimeter (g/25.4 mm) or greater between the first film second surface and the second film first surface according to ASTM F 904-98 (Reapproved 2003).

In some aspects, the average density of the second film is less than the average density of the first film.

In some aspects, the second film may comprise a multilayer film.

In some aspects, the second film is a coextruded film.

In some aspects, the multilayer packaging film may further comprise a printed layer comprising an ink selected from the group comprising a polyvinyl butyral (PVB)-based ink, a polyurethane (PU)-based ink, a nitrocellulose-based ink, and an acrylate-based ink, wherein the printed layer is positioned between the first film second surface and the second film first surface.

Other aspects that may be used individually or in combination with respect to the first or second aspect are as follows.

In some aspects, the multilayer packaging or the packaging film may comprise a first primer layer comprising the first primer material.

In some aspects, the multilayer packaging film or the packaging film may further comprise a first primer layer comprising a blend comprising the first primer material and the second primer material.

In some aspects, the multilayer packaging film or the packaging film may further comprise a second primer layer comprising the second primer material.

In some aspects, the first polymer comprises a material selected from the group comprising polyester, polyamide, and polyethylene.

In some aspects, the first film first surface comprises the multilayer packaging film first surface or the packaging film first surface.

In some aspects, the first primer layer comprises a thickness in a range of from greater than 0% to 20% of the thickness of the multilayer packaging film.

In some aspects, the second primer layer comprises a thickness in a range of from greater than 0% to 20% of the thickness of the multilayer packaging film.

In some aspects, the first film is positioned adjacent to the first primer layer.

In some aspects, the first film is an oriented film.

In some aspects, the first polymer may comprise a single polymer in a range of from 90% to 100% of the single polymer, by weight.

In some aspects, the isocyanate-containing component is selected from the group comprising a polyurethane adhesive system having an isocyanate-terminated component, an isocyanate-based adhesive coreactant, and combinations thereof.

In some aspects, the polyurethane (PU)-based ink may comprise a polyester backbone or a polyether backbone.

In some aspects, a package may comprise the multilayer packaging film or the packaging film.

### BRIEF DESCRIPTION OF THE DRAWINGS

The disclosure may be more completely understood in consideration of the following detailed description of various embodiments of the disclosure in connection with the accompanying drawings, in which:

FIG. 1 illustrates a schematic cross-sectional view of an embodiment of a multilayer packaging film;

FIG. 2 illustrates a schematic cross-sectional view of an embodiment of a multilayer packaging film;

FIG. 3 illustrates a schematic cross-sectional view of an embodiment of a packaging film;

FIG. 4 illustrates a schematic cross-sectional view of an embodiment of a packaging film;

FIG. 5 illustrates a schematic perspective view of an embodiment of a package formed from the multilayer packaging film or packaging film;

FIG. 6 illustrates a schematic cross-sectional view of an embodiment of a package formed from the multilayer packaging film or packaging film;

FIG. 7 illustrates a schematic perspective view of an embodiment of a thermoformed component; and

FIG. 8 illustrates a schematic perspective view of an embodiment of a thermoformed component.

The drawings show some but not all embodiments. The elements depicted in the drawings are illustrative and not necessarily to scale, and the same (or similar) reference numbers denote the same (or similar) features throughout the drawings.

### DETAILED DESCRIPTION

Described herein are multilayer packaging films that include thermoformable films, recyclable films, and thermoformed components made therefrom. The multilayer packaging film may be suitable for packaging products that might be sensitive to oxygen or moisture. Barrier materials may be included in the film and in component structures to prevent the ingress of oxygen and/or moisture. The multilayer packaging films, thermoformable films, and recyclable films may be or may not be thermoformed to form packages that contain a product. Packages may include stand-up pouches, or a thermoformed component made from the multilayer packaging film. A thermoformed component may include a lidding film heat sealed to the component, creating a package that contains the product. Suitable products may be, but are not limited to, fresh food, refrigerated foods, shelf-stable foods, pharmaceuticals, nutraceuticals, and non-food products, such as medical products, consumer goods, cosmetics, and chemicals. The product includes a moisture content from 0% to 100%, by weight of the product. The term “moisture content”, as used herein, refers to the weight of the water contained in a product and is expressed as a percentage of the product weight. A moisture content of 0% indicates that the product is completely dry and a moisture content of 100% by weight indicates that the product is completely saturated with liquid.

The packages described herein incorporate multilayer packaging films and may include packages that include at least two packaging components to contain products. One component may be a thermoformed component, formed from the multilayer packaging films described herein. The other component may be a lid component. The other component or lidding material is configured from a film or materials that are capable of being hermetically heat sealed to the thermoformed component, producing a protective package for the product. The lidding material may be combined with the thermoformed components in a variety of ways including, but not limited to, heat sealing, gluing, or welding.

The multilayer packaging films, thermoformable films, recyclable films, and thermoformed components can advantageously be processed to recover the polymers that may be recyclable without contamination from other packaging components, barrier material polymers, or inks, for example. The multilayer packaging films, thermoformable films, recyclable films, and thermoformed components, for example, can be introduced into a separation process where a polymer (e.g., desired recovery polymer), such as a thermoformable polymer or recyclable single polymer, may be separated from the barrier material polymers, other packaging components, or inks. In some embodiments, the multilayer packaging films, thermoformable films, recyclable films, thermoformed components, and packaging components (e.g., lidding material) are recyclable in the same recycle process. In some embodiments, the packaging components, thermoformed components, recyclable films, thermoformable films, or multilayer packaging films may remain attached to a corresponding film or component such that the entire package may be recycled together without being separated from each other.

For example, a wash-sink-float separation process generally includes the multilayer packaging films, including thermoformable films, recyclable films, and thermoformed components, to be flaked or granulated (e.g., cut into small pieces) and washed in an aqueous or aqueous detergent solution that allows the polymer and the barrier materials to be separated from each other. The flaked polymer can be recovered from the process and can be reused (e.g., recycled).

The multilayer packaging films, thermoformable films, recyclable films, and thermoformed components have the distinct advantage of being recycled in a single polymer recycling stream (e.g., polyester, polypropylene, polyethylene). This advantage is achieved while maintaining good bond strength between the layers of the multilayer packaging films and allowing acceptable delamination times of the layers in the wash-sink-float separation process.

### Multilayer Packaging Film and Packaging Film

A multilayer packaging film and packaging film includes at least a first film, a first primer material, a second primer material, and a second film. The first film includes a first polymer. The second film includes a second polymer. The second film may additionally include a barrier material. The first film includes a first surface that includes a first surface of the multilayer packaging film and a second surface that opposes the first surface. The second film includes a first surface and a second surface that opposes the first surface. The second surface of second film includes a second surface of the multilayer packaging film. The first primer material and the second primer material are positioned between the second surface of the first film and the first surface of the second film. The positioning of the first and second primer materials allows the first film to separate from the second film, for example, in a wash-sink-float separation process, such that the first polymer of the first film and/or the second polymer of the second film can be recovered and recycled. The polymer that makes up most of the film structure is usually the polymer of interest to be collected in a recycling stream. For example, in rigid, formed component packages, polyester may be the polymer of interest for collection, and in flexible film packages, polyethylene may be the polymer of interest for collection. In an embodiment, the first polymer may be a thermoformable polymer. In an embodiment, the multilayer packaging film may be a thermoformable film. In an embodiment, the multilayer packaging film may be a recyclable film. In an embodiment, the first film includes a first surface of the multilayer packaging film. In an embodiment, the second film includes a second surface of the multilayer packaging film. In an embodiment, the first film includes the first surface of the multilayer packaging film, and the second film includes the second surface of the multilayer packaging film.

The multilayer packaging film includes a thickness. The first film includes a first film thickness, and the second film includes a second film thickness. The multilayer packaging film includes a first primer layer that includes the first primer material. The first primer layer includes a first primer layer thickness that may be in a range of from greater than 0% to 20% of the thickness of the multilayer packaging film. In an embodiment, the first primer layer thickness may be from 0.01% to 0.1%, 0.1% to 0.5%, 0.5% to 1%, 1% to 5%, 5% to 10%, 10% to 15%, 15% to 20%, or any range or combination of ranges therein of the multilayer packaging film.

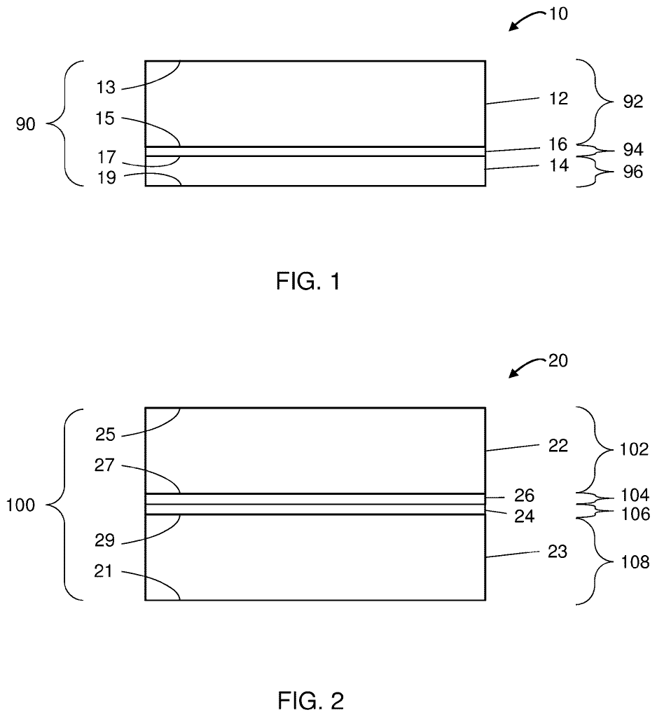

A multilayer packaging film 10, shown in FIG. 1, includes at least a first film 12, a first primer layer 16, and a second film 14. The multilayer packaging film 10 includes the first film 12 that includes a first polymer. The second film 14 includes at least a second polymer. The first film 12 includes a first surface 13 that includes a first surface of the multilayer packaging film 10 and a second surface 15 that opposes the first surface 13. The second film 14 includes a first surface 17 and a second surface 19 that opposes the first surface 17. The second surface 19 of second film 14 includes a second surface of the multilayer packaging film 10. The first primer layer 16 is positioned between the second surface 15 of the first film 12 and the first surface 17 of the second film 14. The first primer layer shown in this embodiment includes a blend of a first primer material and a second primer material. The positioning and composition of the first primer layer 16 allows the first film 12 to separate from the second film 14, for example, in a wash-sink-float separation process, such that the first polymer of the first film 12 and/or the second polymer of the second film 14 can be recovered and recycled. In an embodiment, the first polymer may be a thermoformable polymer. In an embodiment, the multilayer packaging film may be a thermoformable film. In an embodiment, the multilayer packaging film may be a recyclable film. In an embodiment, the first film includes a first surface of the multilayer packaging film. In an embodiment, the second film includes a second surface of the multilayer packaging film. In an embodiment, the first film includes the first surface of the multilayer packaging film and the second film includes the second surface of the multilayer packaging film.

The multilayer packaging film 10 includes a thickness 90. The first film 12 includes a first film thickness 92, the first primer layer 16 includes a primer layer thickness 94, and the second film 14 includes a second film thickness 96. The first primer layer thickness 94 may be in a range of from greater than 0% to 20% of the thickness of the multilayer packaging film. In an embodiment, the first primer layer thickness may be from 0.01% to 0.1%, 0.1% to 0.5%, 0.5% to 1%, 1% to 5%, 5% to 10%, 10% to 15%, 15% to 20%, or any range or combination of ranges therein of the multilayer packaging film.

In some embodiments, the multilayer packaging film may include a second primer layer. With refence to FIG. 2, a multilayer packaging film 20 includes a first film 22, a first primer layer 26, a second primer layer 24, and a second film 23. The first film 22 includes a first surface 25 that includes a first surface of the multilayer packaging film and an opposing second surface 27. The second film 23 includes a first surface 29 and an opposing second surface 21 that includes a second surface of the multilayer packaging film 20.

The multilayer packaging film 20 includes a thickness 100. The first film 22 includes a first film thickness 102, the first primer layer 26 includes a primer layer thickness 104, and the second primer layer 24 includes a second primer layer thickness 106. The second film 23 includes a second film thickness 108. The first primer layer thickness may be in a range of from greater than 0% to 20% of the thickness of the multilayer packaging film. The second primer layer thickness may be in a range of from greater than 0% to 20% of the thickness of the multilayer packaging film. In an embodiment, the first primer layer thickness may be from 0.01% to 0.1%, 0.1% to 0.5%, 0.5% to 1%, 1% to 5%, 5% to 10%, 10% to 15%, 15% to 20%, or any range or combination of ranges therein of the multilayer packaging film. In an embodiment, the second primer layer thickness may be from 0.01% to 0.1%, 0.1% to 0.5%, 0.5% to 1%, 1% to 5%, 5% to 10%, 10% to 15%, 15% to 20%, or any range or combination of ranges therein of the multilayer packaging film.

The term “thermoformable polymer”, as used herein, refers to polymers that when heated above a minimum temperature will soften to a point where they can be physically formed into a desired shape, and when heated above a maximum temperature, the polymer cannot be web processed.

As used herein, the term “film” is a monolayer or multilayer web that has an insignificant z-direction dimension (thickness) as compared to the x- and y-direction dimensions (length and width). Films are generally regarded as having two major surfaces, opposite each other, expanding in the length and width directions. The surface of the film that is not connected to another layer or film is an exposed surface of the film. Films may be built from an unlimited number of films or layers; the films or layers being bonded together to form a multilayer film.

The term “layer”, as used herein, refers to a building block of films that is a structure of a single polymer or a homogeneous or heterogeneous blend of materials. A layer may contain other non-polymeric materials and may have additives. Layers may be continuous or discontinuous (i.e., patterned) with the length and width of the film. In a monolayer film, “film”, “sheet” and “layer” are synonymous.

The term “multilayer”, as used herein, refers to a single film structure, which may have a plurality of layers, generally in the form of a sheet or web that can be made from a polymeric material or a non-polymeric material bonded together by any conventional means known in the art, (i.e., coextrusion, lamination, coating, or a combination thereof).

The first film of the multilayer packaging film includes a first polymer. In some embodiments, the first polymer may include thermoformable functionality. Non-limiting examples of first polymers include single polymer types or groups of polystyrene, polyester, polypropylene, polyethylene, polyamide, and blends thereof. Examples of each of these single polymer types or groups include, but are not limited to, high impact polystyrene (HIPS), polyethylene terephthalate (PET), amorphous polyethylene terephthalate (APET), crystalline polyethylene terephthalate (CPET), glycol-modified polyethylene terephthalate (PETG), polyethylene (PE) homopolymer, high density polyethylene (HDPE), polypropylene (PP) homopolymer, PP copolymer, and polycarbonate. In some embodiments, the thermoformable polymer is selected for its compatibility with a single polymer recycling stream or process. In some embodiments, the first polymer is selected for aesthetics, rigidity, thermoformability, or abuse resistance for a package resulting from the multilayer packaging film. In an embodiment, the first polymer includes a polypropylene. In another embodiment, the first polymer includes a polyester. In a further embodiment, the first polymer is a polyester.

The first polymer may include a melting point from 100° C. to 255° C. (212° F. to 491° F.) or any range or combination of ranges therein. In an embodiment, the first polymer may include a melting point from 130° C. to 225° C. (266° F. to 437° F.). In another embodiment, the first polymer includes a polyester and includes a melting point from 225° C. to 255° C. (437° F. to 491° F.). In other embodiments, the first polymer may be without a melting point, i.e., the first polymer may be amorphous because it is incapable of crystallizing (e.g., atactic polystyrene) or it is processed in a way that prevents substantial formation of crystals (e.g., APET).

As used throughout this application, the terms “polystyrene”, “PS”, or “styrenic based polymers” refer to a homopolymer or copolymer having at least one styrene monomer linkage (such as benzene (i.e., C₆H₆) having an ethylene substituent (i.e., phenyl group, C₆H₅) pendant to the repeating backbone of the polymer. The styrene linkage can be represented by the general formula: [CH₂—CH(C₆H₅)]ₙ.

As used throughout this application, the term “polyester” refers to a homopolymer or copolymer having an ester linkage between monomer units which may be formed, for example, by (a) condensation polymerization reactions between a dicarboxylic acid and a diol, (b) condensation reaction of hydroxy acids, or (c) ring opening of glycolide, lactide, (d) transesterification of a diol and a diester known as bis-HET, etc. The ester linkage can be represented by the general formula: [O—R—OC(O)—R′—C(O)]ₙ where R and R′ are the same or different alkyl (or aryl) group and may be generally formed from the polymerization of dicarboxylic acid and diol monomers containing both carboxylic acid and hydroxyl moieties. The dicarboxylic acid (including the carboxylic acid moieties) may be linear or aliphatic (e.g., oxalic acid, maleic acid, succinic acid, glutaric acid, adipic acid, pimelic acid, suberic acid, azelaic acid, sebacic acid, and the like) or may be aromatic or alkyl substituted aromatic (e.g., various isomers of phthalic acid, such as paraphthalic acid (or terephthalic acid), isophthalic acid, naphthalic acid, and 2,5-furandicarboxylic acid). Specific examples of a useful diol include but are not limited to ethylene glycol, propylene glycol, trimethylene glycol, 1,4-butane diol, neopentyl glycol, 1,4-cyclohexane dimethanol (CHDM), cyclohexane diol, 2,2,4,4-tetramethyl-1,3-cyclobutanediol, diethylene glycol and the like. Polyesters may include (a) a homopolymer or copolymer of alkyl-aromatic esters including but not limited to polyethylene terephthalate (PET), amorphous polyethylene terephthalate (APET), crystalline polyethylene terephthalate (CPET), glycol-modified polyethylene terephthalate (PETG) and polybutylene terephthalate, (b) a copolymer of terephthalate and isophthalate including but not limited to polyethylene terephthalate/isophthalate copolymer, (c) a homopolymer or copolymer of aliphatic esters including but not limited to polylactic acid (PLA), (d) polyhydroxyalkonates including but not limited to polyhydroxypropionate, poly(3-hydroxybutyrate) (PH3B), poly(3-hydroxyvalerate) (PH3V), poly(4-hydroxybutyrate) (PH4B), poly(4-hydroxyvalerate) (PH4V), poly(5-hydroxyvalerate) (PH5V), poly(6-hydroxydodecanoate) (PH6D), (e) polyethylene furanoate (PEF), and blends of any of these materials.

As used throughout this application, the term “copolymer” refers to a polymer product obtained by the polymerization reaction or copolymerization of at least two distinct repeat units. The term “copolymer” is also inclusive of the polymerization reaction of three, four, or more monomer species having reaction products referred to terpolymers, quaterpolymers, etc.

As used throughout this application, the term “modified” refers to a chemical derivative, such as one having any form of anhydride functionality (e.g., anhydride of maleic acid, crotonic acid, citraconic acid, itaconic acid, fumaric acid, etc.), whether grafted onto a polymer, copolymerized with a polymer, or blended with one or more polymers. The term is also inclusive of derivatives of such functionalities, such as acids, esters and metal salts derived from such.

As used throughout this application, the term “polypropylene” or “PP” refers to a homopolymer or copolymer having at least one propylene monomer linkage within the repeating backbone of the polymer. The propylene linkage can be represented by the general formula: —CH₂—CH (CH₃)—.

As used throughout this application, the term “polyethylene” or “PE” refers to, unless indicated otherwise, ethylene homopolymers as well as copolymers of ethylene with at least one alpha-olefin. The term will be used without regard to the presence or absence of substituent branch groups.

As used throughout this application, the term “polycarbonate” refers to an oligomer or polymer including residues of one or more dihydroxy compounds (e.g., dihydroxy aromatic compounds) joined by carbonate linkages. This encompasses homopolycarbonates, copolycarbonates, and (co) polyester carbonates. The polycarbonate may include any polycarbonate material or mixture of polycarbonate materials. The polycarbonate may be a homopolymer including repeating units derived from bisphenol A. The polycarbonate may include polycarbonate monomers such as, but not limited to, 2-phenyl-3,3′-bis(4-hydroxy phenyl) phthalimidine (PPPBP) and dimethyl bisphenol cyclohexane (DMBPC).

The terms “polyamide” or “nylon”, as used herein, refer to homopolymers or copolymers having recurring amide linkages and may be formed by any method known in the art. Recurring amide linkages may be formed by the reaction of one or more diamines and one or more diacids. Non-limiting examples of suitable diamines include 1,4-diamino butane, hexamethylene diamine, decamethylene diamine, metaxylylene diamine, and isophorone diamine. Non-limiting examples of suitable diacids include terephthalic acid, isophthalic acid, 2,5-furandicarboxylic acid, succinic acid, adipic acid, and azelaic acid.

Polyamides may also be formed by the ring-opening polymerization of suitable cyclic lactams like ε-caprolactam, ω-undecanolactam and ω-dodecalactam.

Non-limiting examples of suitable polyamides include poly(ε-caprolactam) (nylon 6), poly(ω-undecanolactam) (nylon 11), poly(ω-dodecalactam) (nylon 12), poly(hexamethylene adipamide) (nylon 6,6), poly(hexamethylene adipamide-co-caprolactam) (nylon 66/6), poly(caprolactam-co-hexamethylene adipamide) (nylon 6/66), poly(caprolactam-co-hexamethylene azelamide) (nylon 6/69), poly(m-xylylene adipamide) (MXD6) and poly(hexamethylene terephthalamide-co-hexamethylene isophthalamide) (nylon 6I/6T).

The first film may be a monolayer film or a multilayer film. In an embodiment, the first film may be an extrusion coated film that is formed by extrusion coating a surface that is adjacent to the first film with a composition that includes the first polymer. In another embodiment, the first film may be a coextruded multilayer film that is subsequently laminated to an adjacent surface. In some embodiments, the first film is a blown film. The term “blown film”, as used herein refers to a film produced by the blown extrusion process. In the blown extrusion process, streams of melt-plastified polymers are forced through an annular die having a central mandrel to form a tubular extrudate. The tubular extrudate may be expanded to a desired wall thickness by a volume of fluid (e.g., air or other gas) entering the hollow interior of the extrudate via the mandrel, and then rapidly cooled or quenched by any of various methods known to those of skill in the art.

The first film may be an oriented film that is monoaxially oriented or biaxially oriented by any known means that is not limited to a single bubble blown film extrusion process or a slot cast sheet extrusion process with subsequent stretching, for example, by tentering. Machine direction orientation may be accomplished using heated rolls rotating at different speeds and pulling or drawing the film tube in the machine direction. Oriented first films may provide strength and abuse resistance to a multilayer packaging film that is used to form a flexible package, for example, stand up pouches, pillow pouches, and form-fill-seal packages.

The multilayer first film includes as many layers as desired and at least two layers. Multilayer first films that include at least three layers, the film includes an inner layer. As used throughout this application, the term “inner layer” refers to a layer that is positioned between two other layers. As used throughout this application, the term “surface layer” refers to a layer that does not have another layer on at least one of its major surfaces, (i.e., a surface layer that is on the exterior of the multilayer film). In an embodiment, the first film includes a surface layer of the multilayer packaging film. In another embodiment, the second film includes a surface layer of the multilayer packaging film. In an embodiment, the first film includes a surface layer of the multilayer packaging film and the second film includes an opposing surface layer of the multilayer packaging film.

The second film may be a monolayer film or a multilayer film. In an embodiment, the second film may be an extrusion coated film that is formed by extrusion coating a surface that is adjacent to the second film with a composition that includes the second polymer. In another embodiment, the second film may be a coextruded multilayer film that is subsequently laminated to an adjacent surface. In some embodiments, the second film may be a blown film. The multilayer second film includes as many layers as desired and having at least two layers. In any embodiment, the second film may include a barrier material.

The term “barrier material”, as used herein, refers to a material that significantly reduces the transmission of one or more molecular species through a layer in which the barrier material is present. A barrier material may be included in a surface layer or an inner layer of the second film. A barrier material may limit or reduce the permeation of migratory species such as moisture, oxygen, and/or other gasses. Barrier materials typically include metals (e.g., foil, metal oxides, etc.) or polymers providing barrier. Barrier materials useful for multilayer packaging films and/or thermoformed components include but are not limited to polymers including ethylene vinyl alcohol copolymer (EVOH), PVDC, high density polyethylene (HDPE), cyclic olefin copolymers (COC), polyamides, polyacrylates, and polypropylenes. Barrier layers may comprise blends of materials. The second film may include multiple barrier layers, that is, a second barrier layer, a third barrier layer, and so on. The second film may further include additional layers to provide bulk or adhesion among other things. In some embodiments, the first film additionally may include a layer that includes a barrier material.

In some embodiments, the barrier material includes an ethylene vinyl alcohol copolymer. The terms “ethylene vinyl alcohol copolymer” or “EVOH”, as used herein, refer to copolymers comprised of repeating units of ethylene and vinyl alcohol. Ethylene vinyl alcohol copolymers can be represented by the general formula: [(CH₂—CH₂)ₘ—(CH₂—CH (OH))ₙ]. Preferably, ethylene vinyl alcohol copolymers comprise from about 25 mole percent to about 48 mole percent ethylene. The type of EVOH may be selected to be one of the grades especially designed for thermoforming applications, as are known in the art. An example of EVOH that may be thermoformable is Soarnol™ ET3803 (38 mol % ethylene content) available from Soarus L.L.C. EVOH is known to reduce the permeation of oxygen and other gasses through polymeric based packaging films. EVOH includes a density from 1.12 g/cm³ to 1.24 g/cm³.

The multilayer packaging film may have an oxygen transmission rate (OTR) when an oxygen barrier material such as EVOH is included in the multilayer packaging film composition. The OTR may be less than 20 cubic centimeters per meter² per 24 hours (cc/m²/24 hours), or between 0.05 cc/m²/24 hours and 5.0 cc/m²/24 hours, between 5.0 cc/m²/24 hours and 10.0 cc/m²/24 hours, between 10.0 cc/m²/24 hours and 20.0 cc/m²/24 hours, or any range or combination of ranges therein, where cc is cubic centimeters, when measured at 23° C. and 0% relative humidity (RH) using ASTM D3985. The multilayer packaging film may have an oxygen transmission rate of less than 500 cubic centimeters per meter² per 24 hours (cc/m²/24 hours). Without an oxygen barrier material such as EVOH, or a substantial thickness to increase barrier, for example, the multilayer packaging film may include an oxygen transmission rate from 2,000 cc/m²/24 hours or greater. In some embodiments, the multilayer packaging film may include an oxygen scavenging material.

The barrier material may provide moisture barrier. Some embodiments of the barrier material may include high density polyethylene (HDPE) for moisture barrier improvements. The terms “high density polyethylene” or “HDPE”, as used herein, refer to both (a) homopolymers of ethylene that may have densities from about 0.960 g/cm³ to about 0.970 g/cm³ and (b) copolymers of ethylene and an alpha-olefin (usually 1-butene or 1-hexene) that may have densities from about 0.940 g/cm³ to about 0.958 g/cm³. HDPE includes polymers made with Ziegler or Phillips type catalysts, polymers made with single-site metallocene catalysts, and polymers made with non-metallocene single-site catalysts. HDPE also includes high molecular weight “polyethylenes”.

In contrast to HDPE, whose polymer chain may exhibit sparse branching, are “ultra high molecular weight polyethylenes”, which are essentially unbranched specialty polymers having a much higher molecular weight than the high molecular weight HDPE. HDPE includes a density from 0.94 g/cm³ to 0.97 g/cm³. The second film may include one, two, three, four, or more separate layers comprising HDPE, each consisting essentially of HDPE. That is, the HDPE may be accompanied by other minor components such as slip, antiblock, processing aid, nucleation additives, or hydrocarbon additives, such that the blend consists of at least 80% HDPE.

Some embodiments of the barrier material may include polypropylene (PP) for moisture barrier improvements. The second film may include one, two, three, four, or more separate layers comprising PP, each consisting essentially of PP. That is, the PP may be accompanied by other minor components such as slip, antiblock, processing aid, nucleation additives, or hydrocarbon additives, such that the blend consists of at least 80% PP. In some embodiments, the second film may include more than one barrier layer where each barrier layer includes a barrier material that is different from at least one of the other barrier layers.

The multilayer packaging film may have a moisture transmission rate, when a moisture barrier material is included in the multilayer packaging film compositions of less than 15.5 grams per meter² per 24 hours (g/m²/24 hours), between 0.0155 g/m²/24 hours and 15.0 g/m²/24 hours, or between 0.05 g/m²/24 hours and 10.0 g/m²/24 and including any range or combination of ranges therein when measured at 38° C. and 90% RH using ASTM F1249.

The first film and/or the second film may include a pigment within any of the polymer layer(s) that form the first and second films. Pigment is often included in the structure to produce colored components or components that require light blocking. In some instances, the pigmented first film or second film provides optical detection in a wash-sink-float-separation process. The layer or layers including the pigment may be located centrally to the multilayer packaging film structure. In this context, the term “centrally” is meant to indicate that the pigment is near the center of the structure, although may not be necessarily at exactly the center of the structure. In an embodiment, the barrier layer includes the pigment. In another embodiment, the barrier layer including HDPE includes the pigment.

Other inner layers of the second film may comprise any materials known to be compatible and useful to packaging. Inner layers may be functional. For example, inner layers may provide barrier (barrier materials), adhesion (adhesive or tie materials), thermoforming stability, or any other function known to be useful for multilayer packaging films.

As used throughout this application, the term “tie material” refers to a polymeric material serving a primary purpose or function of adhering two surfaces to one another, typically the planar surfaces of two film layers. A tie material adheres one film layer surface to another film layer surface. The tie material may comprise any polymer, copolymer or blend of polymers having a polar group or any other polymer, homopolymer, copolymer or blend of polymers, including modified and unmodified polymers (such as grafted copolymers), which provide sufficient interlayer adhesion to adjacent layers comprising otherwise non-adhering polymers.

The first primer material includes an ionomeric water dispersible material that is positioned between the first film second surface and the second film first surface. The first primer material includes an ionomeric water dispersible material. The term “ionomeric”, as used herein, refers to polymers that include ionic groups that are randomly and or regularly distributed along the polymer backbone. These ionic groups can dissociate in the presence of water or other polar solvents, leading to the formation of mobile ions that can facilitate various physical and chemical properties of the material. The term “water dispersible”, as used herein, refers to a material that may be dispersible, soluble, or emulsifiable in water or another solvent. The material may include but is not limited to an acidic moiety, a sulfopolyester, or a waterborne polyurethane (e.g., polyester urethanes and polyether urethanes). “Dispersible”, as used in this application, means that some structure of the water dispersible material is retained (e.g., material or particles are suspended in the solvent). “Soluble”, as used in this application, means that the water dispersible material dissolves in the solvent. “Emulsifiable”, as used in this application, means that the water dispersible material is present as droplets, of microscopic or ultramicroscopic size, and is distributed throughout the solvent with a surfactant or a stabilizer. Non-limiting examples of suitable solvents include water or isopropyl alcohol (IPA).

Ionomeric water dispersible acidic moieties may include copolymers of monobasic ethylenically unsaturated carboxylic acids with ethylene, such as ethylene acrylic acid (EAA) or ethylene methacrylic acid (EMAA) that may be partially neutralized with metal salts, for example, sodium or zinc. Ionomeric water dispersible acidic moieties may further include polyacrylic acids (PAA) such as ionically or covalently crosslinked polycarboxylates, polymethacrylates such as polymethacrylic acid (PMAA), mixtures of polyacrylic acid and polymethacrylic acid, and partially or fully neutralized forms thereof. In an embodiment, the ionomeric water dispersible material including acidic moieties may include EAA, EMAA, PAA, PMAA, or combinations thereof. Suitable ionomeric water dispersible acidic moieties, such as PAA, include those available under the trade name of ACUMER developed by Dow.

lonomeric water dispersible sulfopolyesters are formed by melt-phase polymerization of glycols and aromatic diacids. Typical monomers used in the production of water dispersible sulfopolyesters include isophthalic acid, 5-sodiosulfoisophthalic acid, 1,4-cyclohexanedimethanol, and diethylene glycol. Suitable water dispersible sulfopolyesters include those available under the trade name of EASTEK polymer dispersions developed by Eastman.

The second primer material is selected from the group that includes a melamine-formaldehyde-based water dispersible material, a polyethylenimine (PEI)-based water dispersible material, an isocyanate-containing component, and combinations thereof. The isocyanate-containing component may include a polyurethane adhesive system having an isocyanate-terminated component or an isocyanate-based adhesive coreactant, for example. The second primer material is positioned between the first film second surface and the second film first surface.

The multilayer packaging film includes the first primer layer that includes the first primer material.

The multilayer packaging film may further include the second primer material in the first primer layer or in a second primer layer. That is, in one embodiment, the first primer layer may include a blend of the first primer material and the second primer material. In another embodiment, the second primer material may be included in a second primer layer that is a discrete layer different from the first primer layer.

The combination of the first primer material and the second primer material, either blended together in the first primer layer or each primer material included in discrete layers including the first primer layer and the second primer layer, is uniquely configured to (a) facilitate bond strength between the first film and the second film such that the multilayer packaging film can withstand formation into a package and fulfill its intended function, and (b) allow for separation of the first film from the second film. For example, the first primer layer (i.e., blend of first primer material and the second primer material) or the first primer layer (i.e., first primer material) and the second primer layer (i.e., second primer material) can partially or completely dissolve in a wash-sink-float-separation process. The multilayer packaging film, or resulting thermoformed components, advantageously can provide barrier and contain high moisture content products without separation between the first and second films until subjected to a separation process.

The multilayer packaging film includes interlaminar bond strength between the first film and the second film as indicated by peak bond strength and average bond strength according to ASTM F 904-98 (Reapproved 2003). The interlaminar bond strength is a measurement between where the first primer layer and/or the second primer layer interfaces with the first film and/or the second film allowing separation to occur in a separation process. In some instances, the separation interface may occur between (a) the first film and the first primer layer, (b) the second film and the first primer layer, (c) the second film and the second primer layer, (d) within the first primer layer and/or the second primer layer, or (e) a combination of (a) through (d). A peak or average bond strength between the first film and the second film disclosed herein, includes a measurement of (a), (b), (c), (d), or (e). In some instances, the multilayer packaging film can include relatively low peak and average interlaminar bond strengths and in other instances, relatively high peak and average interlaminar bond strengths. For example, a multilayer packaging film that is a thermoformable film that will be formed into a thermoformed component, may only need to have enough interlaminar bond strength to keep the first film bonded to the second film until the multilayer packaging film undergoes a thermoforming process. In another example, a multilayer packaging film that will be formed into a flexible film package may need to have high interlaminar bond strength. The bond strength must be suitable for the particular packaging application as understood by one of skill in the art.

In an embodiment, the multilayer packaging film may include a peak bond strength of from 20 g/25.4 mm or greater between the first film second surface and the second film first surface according to ASTM F 904-98 (Reapproved 2003). In an embodiment, the multilayer packaging film may include a peak bond strength of 100 g/25.4 mm, 200 g/25.4 mm, 300 g/25.4 mm, 400 g/25.4 mm, 500 g/25.4 mm, 600 g/25.4 mm, 700 g/25.4 mm, 800 g/25.4 mm, 900 g/25.4 mm, or 1,000 g/25.4 mm. In other embodiments, the multilayer packaging film may include a peak bond strength of greater than 1,000 g/25.4 mm, 2,000 g/25.4 mm, or greater. In some embodiments, the multilayer packaging film may include a peak bond strength that is so great, the first film and the second film do not separate or that causes destruction of at least one of the first or second films.

In an embodiment, the multilayer packaging film may include an average bond strength of from 20 g/25.4 mm or greater between the first film second surface and the second film first surface according to ASTM F 904-98 (Reapproved 2003). In an embodiment, the multilayer packaging film may include an average bond strength of 100 g/25.4 mm, 200 g/25.4 mm, 300 g/25.4 mm, 400 g/25.4 mm, 500 g/25.4 mm, 600 g/25.4 mm, 700 g/25.4 mm, 800 g/25.4 mm, 900 g/25.4 mm, or 1,000 g/25.4 mm. In other embodiments, the multilayer packaging film may include an average bond strength of greater than 1,000 g/25.4 mm, 2,000 g/25.4 mm, or greater. In some embodiments, the multilayer packaging film may include an average bond strength that is so great, the first film and the second film do not separate or that causes destruction of at least one of the first or second films.

The first primer material may be present in a water dispersible coating that forms the first primer layer in a range of from 1% to 50% of the water dispersible coating by weight or any range or combination of ranges therein, that is indicative of the percent solids in a wet state. In an embodiment, the first primer material may be present in the ionomeric water dispersible coating from 1%, 2%, 3%, 4%, 5%, 10%, 15%, 20%, 25%, 30%, 35%, 40%, 45%, or 50% of the water dispersible coating by weight. In an embodiment, the first primer material may be present in the ionomeric water dispersible coating by weight in a range of from 1% to 5%, 5% to 10%, 10% to 15%, 15% to 20%, 20% to 25%, 25% to 30%, 30% to 35%, 35% to 40%, 40% to 45%, 45% to 50%, or any range or combination of ranges therein. In some embodiments, the ionomeric water dispersible coating may further include a photoinitiator or photosensitizer. That is, the first primer material may be accompanied by other minor components in the ionomeric water dispersible coating.

The second primer material may be present in a coating that forms a blend with the first primer material in the first primer layer or a coating that forms a second primer layer. The second primer material may be present in a range of from 1% to 50% of the coating by weight or any range or combination of ranges therein, that is indicative of the percent solids in a wet state. In an embodiment, the second primer material may be present in the coating from 1%, 2%, 3%, 4%, 5%, 10%, 15%, 20%, 25%, 30%, 35%, 40%, 45%, or 50% of the coating by weight. In an embodiment, the second primer material may be present in the coating by weight in a range of from 1% to 5%, 5% to 10%, 10% to 15%, 15% to 20%, 20% to 25%, 25% to 30%, 30% to 35%, 35% to 40%, 40% to 45%, 45% to 50%, or any range or combination of ranges therein. In some embodiments, the second primer material may be present in an amount of greater than 50%, by weight. The second material may be accompanied by other minor components in the coating.

The multilayer packaging film includes a thickness. The first film includes a first film thickness, the first primer layer includes a first primer layer thickness, and the second film includes a second film thickness. In some embodiments, the multilayer packaging film includes a second primer layer that includes a second primer layer thickness. The first primer layer thickness may be in a range of from greater than 0% to 20% of the thickness of the multilayer packaging film. In an embodiment, the first primer layer thickness may be from 0.01% to 0.1%, 0.1% to 0.5%, 0.5% to 1%, 1% to 5%, 5% to 10%, 10% to 15%, 15% to 20%, or any range or combination of ranges therein of the multilayer packaging film. The second primer layer thickness may be in a range of from greater than 0% to 20% of the thickness of the multilayer packaging film. The second primer layer thickness may be from 0.01% to 0.1%, 0.1% to 0.5%, 0.5% to 1%, 1% to 5%, 5% to 10%, 10% to 15%, 15% to 20%, or any range or combination of ranges therein of the multilayer packaging film.

The second film may be a monolayer or a multilayer film that includes a second polymer. The second polymer may include a barrier material. The barrier material may be included in a barrier layer. The second film may include as many layers as desired in addition to the barrier layer when the second film is a multilayer film.

The second film may have a composition that will allow the formation of a heat seal, thus forming a hermetically sealed package. As used herein, the term “heat seal”, “heat sealable” or “heat sealed” refers to two or more surfaces that have been or can be bonded together by application of both heat and pressure. Heat sealing is a well-known and commonly used process for creating packages and is familiar to those skilled in the art. Possible heat sealable materials included in a second film may include, but are not limited to, acrylate copolymers, polyesters, PE, PP, or hot melts (wax based).

In an embodiment, a multilayer packaging film includes a first film including a first polymer that includes polyester and a second film including a second polymer that includes EVOH. In another embodiment, a multilayer packaging film includes a first film including a first polymer that includes polyester and a second film including a second polymer that includes HDPE. In a further embodiment, a multilayer packaging film includes a first film including a first polymer that includes polyester and a second film including a second polymer that includes PP.

The first primer layer is positioned between the first film and the second film. The first primer layer may indirectly adjoin or directly adjoin the first film or the second film. The multilayer packaging film may include intervening layers, other than the first primer layer, between the first film and the second film, such that the first primer layer may be indirectly adjoined to the first film or the second film. For example, printed layers, adhesive or laminating agent layers, or a second primer layer, may be positioned between the first film and the second film that may also be directly adjoined to the first primer layer. In an embodiment, a first film is directly adjoined to a first primer layer. In an embodiment, a first film is indirectly adjoined to a first primer layer. In an embodiment, a second film is directly adjoined to a first primer layer. In an embodiment, a second film is indirectly adjoined to a first primer layer. In an embodiment, an ionomeric water dispersible coating forming a first primer layer may be applied onto an outer surface of a first film (e.g., first film second surface) by any conventional coating means known in the art (e.g., printing, spray coat, knife coat, etc.) before the first film is connected to a second film. In another embodiment, an ionomeric water dispersible coating forming a first primer layer may be applied to an outer surface of a second film (e.g., second film first surface) before the second film is connected to the first film. In other embodiments, an ionomeric water dispersible coating that forms a first primer layer may be applied to each of a first film and a second film.

The multilayer packaging film may include a second primer layer that is positioned between the first film and the second film. The second primer layer may indirectly adjoin or directly adjoin the first film, the first primer layer, or the second film. For example, intervening layers may be positioned between the first film and the second film that may also be directly adjoined to the second primer layer. In an embodiment, a second film is directly adjoined to a second primer layer. In an embodiment, a second film is indirectly adjoined to a second primer layer. In an embodiment, a first film is directly adjoined to a second primer layer. In an embodiment, a first film is indirectly adjoined to a second primer layer. In an embodiment, a second primer material coating forming a second primer layer may be applied onto an outer surface of a second film (e.g., second film first surface) by any conventional coating means known in the art (e.g., printing, spray coat, knife coat, etc.) before the first film is connected to a second film. In other embodiments, a second primer material coating that forms a second primer layer may be applied to each of a first film and a second film. The multilayer packaging film may include more primer layers than the first primer layer and the second primer layer depending on the number of intervening layers and the particular packaging application.

The printed layer may include an ink selected from the group that includes a polyvinyl butyral (PVB)-based ink, a polyurethane (PU)-based ink, a nitrocellulose-based ink, and an acrylate-based ink. The printed layer is positioned between the first film second surface and the second film first surface of the multilayer packaging film. In some embodiments, the ink may include an isocyanate-containing component. In an embodiment, a printed layer may include a polyurethane (PU)-based ink that includes an isocyanate-containing component. In some embodiments, a polyurethane-based ink may include a polyester backbone.

The first film and the second film may be connected by any conventional means known in the art, such as by heat, adhesive, or by extrusion coating (e.g., extrusion coating a first film onto a second film that includes a first primer layer). In any embodiment, the first primer layer is positioned between the first film and the second film. In an embodiment, a first primer layer is directly connected to a first film and a second film. In an embodiment, a first primer layer is indirectly connected to a first film and a second film. In an embodiment, a first primer layer is coextensive with a first film and a second film. In an embodiment, a first primer layer may include a dry basis weight in a range of from 0.08 grams per meter² (gsm) to 8.14 gsm (0.05 pounds per ream (lb/rm) to 5.0 lb/rm), or any range or combination of ranges therein. In other embodiments, a first primer layer dry basis weight may be greater than 8.14 gsm.

In embodiments that include a second primer layer, the second primer layer is positioned between the first film and the second film of the multilayer packaging film. In an embodiment, a second primer layer is directly connected to a first film and a second film. In an embodiment, a second primer layer is indirectly connected to a first film and a second film. In an embodiment, a second primer layer is coextensive with a first film and a second film. In an embodiment, a second primer layer may include a dry basis weight in a range of from 0.08 grams per meter² (gsm) to 8.14 gsm (0.05 pounds per ream (lb/rm) to 5.0 lb/rm), or any range or combination of ranges therein. In other embodiments, a second primer layer dry basis weight may be greater than 8.14 gsm.

The first film that includes the first polymer may include a thickness that may contribute stiffness to a thermoformed component or part. The required thickness of the thermoformed component may be dependent on the type of material used in the first film. For example, polyester- or polystyrene-based polymers may thermoform easily and evenly and may provide appropriate final part stiffness at a lower thickness when compared to polymers that do not thermoform well or provide the appropriate stiffness. In general, the overall thickness of the first film should be in a range of from 76 microns (3 mil) to 2,540 microns (100 mil) or any range or combination of ranges therein. In some embodiments, the first film thickness is greater than 254 microns (10 mil), greater than 381 microns (15 mil), or greater than 508 microns (20 mil). In other embodiments, the first film thickness is in a range of from 152 microns (6 mil) and 1,270 microns (50 mil) or any range or combination of ranges therein. In some other embodiments the first film thickness is in a range of from between 254 microns (10 mil) and 1,016 microns (40 mil) or any range or combination of ranges therein. In some embodiments, the first film thickness may include a range of from 13 microns (0.5 mil) to less than 76 microns (3 mil). The thickness of each of the first film and the second first film may be the same, similar, or different. The thickness of the second film may have a thickness of less than 127 microns (5 mil). The second film may have a thickness in a range of from 25.4 microns (1 mil) and 200 microns (7.8 mil), more particularly from 76 microns (3 mil) to 140 microns (5.5 mil), or any range or combination of ranges therein. A thickness ratio of the first film thickness to the second first film thickness may be in a range of from 2:1 and 1:2 or any range or combination of ranges therein. In some embodiments the thickness ratio is 1:1. In embodiments where the multilayer packaging film includes a second primer layer, the second primer layer thickness may be the same, similar, or different. A thickness ratio of the first primer layer thickness to the second primer layer thickness may be in a range of from 2:1 and 1:2 or any range or combination of ranges therein. In some embodiments the thickness ratio is 1:1.

In various non-limiting examples, the multilayer packaging film may be like the structures listed below, where “//” indicates the presence of a laminating agent (e.g., adhesive, extrudate):

$$first film / first primer layer , first primer material + optional second primer material / second film ( example where first film may be extrusion coated onto the first primer layer )$$

$$first film / first primer layer , first primer material / second primer layer , second primer material / second film ( example where first film may be extrusion coated onto the first primer layer )$$

$$first film / first primer layer , first primer material + second primer material / / second film ( example where first film and second film are laminated to each other with a laminating agent between the second primer layer and the second film )$$

$$first film / first primer layer , first primer material / / second primer layer , second primer material / second film ( example where first film and second film are laminated to each other with a laminating agent between the first primer layer and the second primer layer )$$

$$first film / first primer layer , first primer material / printed layer / / second primer layer , second primer material / second film ( example where first film and second film are laminated to each other with a laminating agent between the printed layer and the second primer layer )$$

$$first film / first primer layer , first primer material + optional second primer material / printed layer / / second primer layer , first primer material + optional second primer material / second film ( example where first film and second film are laminated to each other with a laminating agent between the printed layer and the second primer layer )$$

$$first film / first primer layer , first primer material + second primer material / / second primer layer , first primer material + second primer material / second film ( example where first film and second film are laminated to each other with a laminating agent between the first primer layer and the second primer layer )$$

$$first film / printed layer / first primer layer , first primer material / / second primer layer , second primer material / second film ( example where first film and second film are laminated to each other with a laminating agent between the first primer layer and the second primer layer )$$

$$first film / printed layer / first primer layer , first primer material + second primer material / / second primer layer , first primer material + second primer material / second film ( example where first film and second film are laminated to each other with a laminating agent between the first primer layer and the second primer layer )$$

$$first film / printed layer / first primer layer , first primer material + second primer material / second film ( example where first film and second film are laminated to each other due to the bonds formed from the printed layer and the first primer layer )$$

$$first film / first primer layer , first primer material + second primer material / second film ( example where first film and second film are laminated to each other due to bonds formed with the first primer layer )$$

Non-limiting examples of various combinations of first films, first polymers, second films, second polymers, first primer materials, second primer materials, and printed layer materials are listed below:

$$APET / ionomeric water dispersible material + melamine - formaldehyde - based water dispersible material / PE + EVOH ; ( APET first film is extrusion coated onto the first primer layer )$$

$$APET / ionomeric water dispersible material + melamine - formaldehyde - based water dispersible material / PE ; ( APET first film is extrusion coated onto the first primer layer )$$

$$APET / ionomeric water dispersible material / melamine - formaldehyde - based water dispersible material / PE ; ( APET first film is extrusion coated onto the first primer layer )$$

$$APET / ionomeric water dispersible material + polyethylenimine - based water dispersible material / PE ; ( APET first film is extrusion coated onto the first primer layer )$$

$$APET / ionomeric water dispersible material / polyethylenimine - based water dispersible material / PE ; ( APET first film is extrusion coated onto the first primer layer )$$

$$APET / ionomeric water dispersible material + isocyanate - containing component / PE ; ( APET first film is extrusion coated onto the first primer layer )$$

$$APET / ionomeric water dispersible material / isocyanate - containing component / PE ; ( APET first film is extrusion coated onto the first primer layer )$$

$$PA / ionomeric water dispersible material / ink / / isocyanate - containing component / PE + EVOH$$

$$BOPA / ionomeric water dispersible material / ink / / isocyanate - containing component / PE + EVOH ( BOPA is biaxially oriented polyamide )$$

$$BOPA / ionomeric water dispersible material / ink / / isocyanate - containing component / PE$$

$$PET / ionomeric water dispersible material / ink / / isocyanate - containing component / PE$$

$$PET / ionomeric water dispersible material + isocyanate - containing component / ionomeric water dispersible material / ink / / ionomeric water dispersible material + isocyanate - containing component / PE$$

$$PET / ionomeric water dispersible material / / isocyanate - containing component / PE$$

$$PET / ionomeric water dispersible material + isocyanate - containing component / / ionomeric water dispersible material + isocyanate - containing component / PE$$

$$PET / ink / ionomeric water dispersible material / / isocyanate - containing component / PE$$

$$PET / ink / ionomeric water dispersible material + isocyanate - containing component / / ionomeric water dispersible material + isocyanate - containing component / PE$$

$$PET / ink / ionomeric water dispersible material + isocyanate - containing component / PE$$

$$PET / ionomeric water dispersible material + isocyanate - containing component / PE$$

A packaging film includes at least a first film, a first primer material, a second primer material, and a printed layer. The first primer material and the second primer material present in the packaging film may be useful for removing or reducing the amount of ink that can contaminate a recycle process. The first film includes a first polymer. The first film includes a first surface that includes a first surface of the packaging film and a second surface that opposes the first surface. The printed layer opposes the first surface of the first film and may include a second surface of the packaging film. The first primer material and the second primer material are positioned between the second surface of the first film and the printed layer. The positioning of the first and second primer materials allows the first film to separate from the printed layer, for example, in a wash-sink-float separation process, such that the first polymer of the first film can be recovered and recycled without contamination from the printed layer. In an embodiment, the packaging film may be a thermoformable film. In an embodiment, the packaging film may be a recyclable film. In an embodiment, the first film includes a first surface of the packaging film. In an embodiment, the printed layer includes a second surface of the packaging film.

The packaging film first film, first polymer, first primer material, second primer material, and printed layer may be the same as those described for the multilayer packaging film.

An over lacquer layer may adjacent to the printed layer when the printed layer is present on an exposed surface of the packaging film. The over lacquer layer may be in direct contact with the printed layer. The over lacquer layer may be in direct contact with portions of packaging film surface that do not include ink (e.g., discontinuous or patterned printed layer). The over lacquer layer may include lacquers also referred to as varnishes, overprints, overprint varnish, etc. The over lacquer layer may further protect the printed layer from flaking off or scuffing when exposed to the rigors of packaging lines, shipping stresses, or consumer misuse. The over lacquer layer may be printed or extruded by means known in the art.

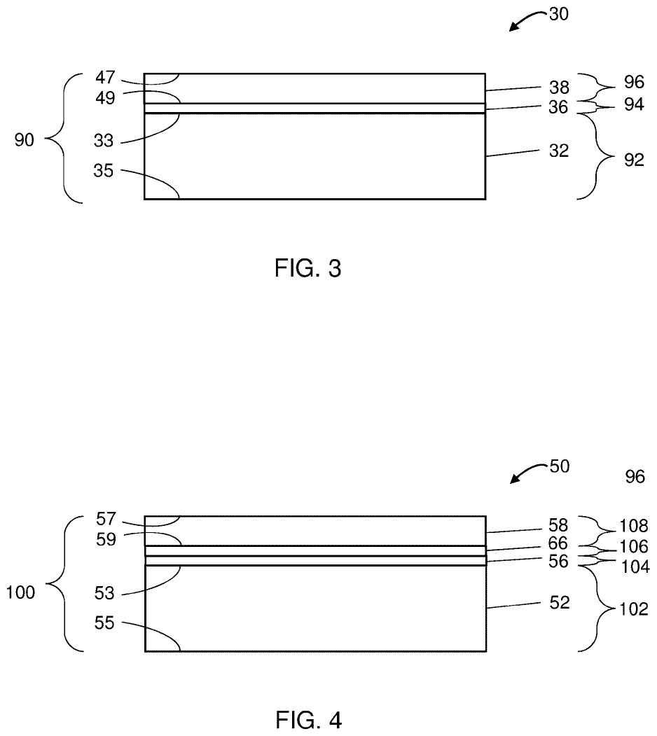

A packaging film 30, shown in FIG. 3, includes at least a first film 32, a first primer layer 36, and a printed layer 38. The printed layer 38 includes a first surface 47 and a second surface 49 that opposes the first surface 47. The first surface 47 of printed layer 38 includes a first surface of the packaging film 30. The packaging film 30 includes the first film 32 that includes a first polymer. The first film 32 includes a first surface 33 and a second surface 35 that opposes the first surface 33 that includes a second surface of the packaging film 30. The first primer layer 36 is positioned between the second surface 49 of the printed layer 38 and the first surface 33 of the first film 32. The first primer layer shown in this embodiment includes a blend of a first primer material and a second primer material. The positioning and composition of the first primer layer 36 allows the first film 32 to separate from the printed layer 38, for example, in a wash-sink-float separation process, such that the first polymer of the first film 32 can be recovered and recycled without contamination from the printed layer 38. In an embodiment, the first polymer may be a thermoformable polymer. In an embodiment, the packaging film may be a thermoformable film. In an embodiment, the packaging film may be a recyclable film. In an embodiment, the first film includes a second surface of the packaging film. In an embodiment, the printed layer includes a first surface of the packaging film. In an embodiment, the first film includes the second surface of the packaging film and the printed layer includes the first surface of the packaging film. The packaging film 30 includes a thickness 90. The first film 32 includes a first film thickness 92, the first primer layer 36 includes a primer layer thickness 94, and the printed layer 38 includes a printed layer thickness 96. The first primer layer thickness may be in a range of from greater than 0% to 20% of the thickness of the packaging film. In an embodiment, the first primer layer thickness may be from 0.01% to 0.1%, 0.1% to 0.5%, 0.5% to 1%, 1% to 5%, 5% to 10%, 10% to 15%, 15% to 20%, or any range or combination of ranges therein of the packaging film.

In some embodiments, the packaging film may include a second primer layer. With refence to FIG. 4, packaging film 50 includes at least a first film 52, a first primer layer 56, a second primer layer 66 and a printed layer 58. The printed layer 58 includes a first surface 57 and a second surface 59 that opposes the first surface 57. The first surface 57 of printed layer 58 includes a first surface of the packaging film 50. The packaging film 50 includes the first film 52 that includes a first polymer. The first film 52 includes a first surface 53 and a second surface 55 that opposes the first surface 53 that includes a second surface of the packaging film 50. The first primer layer 56 is positioned between the second surface 59 of the printed layer 58 and the first surface 53 of the first film 52. The second primer layer 56 is also positioned between the second surface 59 of the printed layer 58 and the first surface 53 of the first film 52. The first primer layer 56 shown in this embodiment includes a first primer material and the second primer layer 66 includes a second primer material. The positioning and composition of the first primer layer 56 and the second primer layer 66 allows the first film 52 to separate from the printed layer 58, for example, in a wash-sink-float separation process, such that the first polymer of the first film 52 can be recovered and recycled without contamination from the printed layer 58. The packaging film 50 includes a thickness 100. The first film 52 includes a first film thickness 102, the first primer layer 56 includes a primer layer thickness 104, and the second primer layer 66 includes a second primer layer thickness 106. The printed layer 58 includes a printed layer thickness 108. The first primer layer thickness may be in a range of from greater than 0% to 20% of the thickness of the packaging film. The second primer layer thickness may be in a range of from greater than 0% to 20% of the thickness of the packaging film. In an embodiment, the first primer layer thickness may be from 0.01% to 0.1%, 0.1% to 0.5%, 0.5% to 1%, 1% to 5%, 5% to 10%, 10% to 15%, 15% to 20%, or any range or combination of ranges therein of the packaging film. In an embodiment, the second primer layer thickness may be from 0.01% to 0.1%, 0.1% to 0.5%, 0.5% to 1%, 1% to 5%, 5% to 10%, 10% to 15%, 15% to 20%, or any range or combination of ranges therein of the packaging film.

In various non-limiting examples, the packaging film may be like the structures listed below:

$$first film / first primer layer , \\ first primer material + second primer material / printed layer$$

$$first film / first primer layer , first primer material / second primer layer , \\ second primer material / printed layer$$

### Recyclable Film

The multilayer packaging films and packaging films described herein may be recycled after their primary use is completed such that the multilayer packaging film or packaging film is a recyclable film. The term “suitable for recycling”, as used herein, is meant to indicate that the films can be converted into a new, useful item by means of reprocessing in a recycle stream (e.g., recycling streams based on a single polymer group, for example, polyester). Reprocessing may entail washing, separating, melting, and forming, among many other steps. Typically, when flexible polymeric packaging is recycled by reprocessing, the material is mechanically chopped into small pieces (e.g., granulated, flaked, etc.), melted, mixed, and reformed into the new product. If multiple incompatible materials are present in the packaging, interactions occur during reprocessing that can cause gels, brittle material, poor appearance, and generally unusable or poor quality products. Using the term “recyclable” indicates that these drawbacks generally are not present.

Qualification as a recyclable material is not regulated by any specific agencies but can be obtained from groups such as the Association of Plastic Recyclers (APR) and How2Recycle™.

The first polymer of the multilayer packaging film or packaging film may be recovered in a wash-sink-float-separation process that allows the first polymer to be recycled. Depending on the application, it may be desirable to recover polymers of the second film. A wash-sink-float-separation process prescribes the multilayer packaging film to be granulated (e.g., flaked, cut into small pieces, etc.) and subjected to the wash step of the process. The first primer material and second primer material partially or completely dissolve in the wash step of the process. The dissolvability of the primer materials or layers may allow the granulated first film including the first polymer to sink and, in embodiments that include second films, the granulated second film to float, or in other configurations, may allow the first film to float and the second film to sink, depending upon the polymers selected for the first film and the second film. The granulated first film and/or the granulated second film may include a portion of the granulated first and/or second primer materials or layers if the primer materials or layers did not completely dissolve.

In embodiments that include second films, the average density of the second film is less than the density of the first polymer. In an embodiment, the average density of the second film is less than the average density of the first film. In an embodiment, the first film includes a first polymer including polyester having a density from 1.23 g/cm³ to 1.40 g/cm³. In this embodiment, the second film may include a barrier layer including a barrier material and having an average density lower than the polyester density. In another embodiment, the first film includes a first polymer including polypropylene having a density from 0.895 g/cm³ to 0.91 g/cm³. In this embodiment, the second film may include a barrier layer including an average density lower than the polypropylene density. A non-limiting process for separating dissimilar materials that includes a granulating process is a wash-sink-float-separation process for the recovery of polyester that is described in a protocol according to the Association of Plastic Recyclers in Document Number PET-P-00, dated Sep. 17, 2019, steps PET-P-01 through PET-P-04 (pages 3-12). Many other processes to separate dissimilar materials may be used as known by one of skill in the art.

In an embodiment, the recyclable film includes a first film that includes greater than 95% of a single polymer. As used in this application, the term “single polymer”, may include single polymer or a blend of the same category of a particular polymer type. In an embodiment, the first film may include greater than 95% of a blend of polyester polymers. In an embodiment, the first film may include greater than 95% of a blend of polypropylene polymers. In an embodiment, the first film may include greater than 95% of a blend of polyethylene polymers.

The positioning and composition of the first and/or second primer layers allows the first film to separate from the second film or the printed layer, for example, in a wash-sink-float separation process, where the single polymer can be recovered and recycled. Recyclable multilayer packaging films or packaging films disclosed herein may be suitable for single polymer recycling streams, such as polyester or polypropylene. Introduction of the recovered portion of the recyclable film into any of these recycling-by-reprocessing avenues may not require additional compatibilizer.

Being suitable for recycling may be obtained by keeping the overall amount of the single polymer in the first film at a high level. Any additives used should be kept to a minimum. Any non-single polymers that are present should be minimized. The total composition of the first film may include a single polymer in an amount in a range of from 90% to 100% of the single polymer, by weight, including any range or combination of ranges therein. In some embodiments, the total composition of the first film is greater than 90%, or greater than 95% of a single polymer, by weight. In an embodiment, the single polymer is present in an amount in a range of from 95% to 100% of the first film, by weight.

The single polymer of the first film may be selected from any of those previously described that may be used as the first polymer of the multilayer packaging film or packaging film of this disclosure. The single polymer can be carefully selected based on its capability to be recycled in a single polymer stream (i.e., recyclable polymer).

The single polymer of the first film of the recyclable film may be recovered in a wash-sink-float-separation process that allows the single polymer to be recycled. The first and/or second primer layers partially or completely dissolve in the wash step of the process. The dissolvability of the primer layers may allow the granulated first film including the single polymer to sink and the granulated second film or printed layer materials to float or may allow the granulated first film including the single polymer to float and the granulated second film or printed layer materials to sink, depending upon the materials selected for the first film, the second film, or printed layer. The granulated second film may include a portion of the granulated primer layer if the primer layer did not completely dissolve. In an embodiment, the average density of the second film is less than the average density of the first film. In another embodiment, the average density of the first film is less than the average density of the second film. In an embodiment, the first film includes a single polymer including a density in a range of from 1.23 g/cm³ to 1.40 g/cm³ and the second film includes an average density that differs from the first film average density. In another embodiment, the first film includes a single polymer including a density in a range of from 0.895 g/cm³ to 0.92 g/cm³ and the second film includes an average density that differs from the first film average density. A granulating process and a wash-sink-float-separation process may be utilized for the recovery of the single polymer.

It was surprisingly found that the primer layers, which constitute a small portion of the recyclable film structure, (a) can provide adequate interlaminar bond strength of the first film to the second film in embodiments that include the second film, and (b) is resistant to dissolution when packages and packaging components are formed from the recyclable film, even when containing high moisture content products. The term “dissolution”, as used herein, refers to structures including layers or films and a primer layer where the separation of the layers or films from each other is due to partial or complete dissolvability of the primer layer(s). The primer layers include water dispersible materials and the layers or films that may separate therefrom may be devoid of primer layer water dispersible materials.

### Packaging and Packaged Product

The multilayer packaging films, packaging films, thermoformable films, and recyclable films disclosed herein can undergo a thermoforming process to form a thermoformed component of a package. Thermoforming is a process by which a film is permanently formed into a desired shape by the application of (a) a differential pressure between the sheet and a mold, (b) heat, (c) the combination of heat and the application of a differential pressure between the film or sheet and a mold, or by any thermoforming technique known to those skilled in the art. In some package embodiments, the multilayer packaging films, thermoformable films, and recyclable films are not thermoformed and may be used to form flexible film packages such as, but not limited to, stand-up pouches, sachets, or pillow packs. In other embodiments, the multilayer packaging films, thermoformable films, and recyclable films may be formed around a forming collar of a packaging machine (e.g., cold forming, cold formed) for proper processability and for the formation of a shallow pocket (e.g., 15 mm to 25 mm) in the film that is desirable for packages referred to as a “deli pack” or a “sandwich pack”, for example. In another example, the multilayer packaging films, thermoformable films, and recyclable films may be formed into trays or other rigid packaging components or parts where the film may also have pockets formed therein at a deeper draw than cold forming. Thermoformed components may have one or more compartments and may take a wide variety of shapes and designs. The thermoformed component may include another component (e.g., lidding material, another thermoformed component, etc.) to form a package that contains a product.

Non-limiting examples of packages that may be formed from the multilayer packaging films, packaging films, thermoformable films, or recyclable films disclosed herein may include little to no degree of thermoforming, such as flexible film pouches or cold-formed deli-pack pouches. Other thermoformed components, such as creamer cups, pudding cups, or trays, for example, may contain a variety of products, food or non-food, that include a moisture content ranging from 0% to 100% or any range or combination of ranges therein. Packages or thermoformed components formed from the multilayer packaging films, thermoformable films, and recyclable films disclosed herein are well suited to contain products that include a moisture content of greater than 30%, for example, 40%, 50%, 60%, 70%, 80%, 90%, 100%, or any moisture content therebetween. In an embodiment, packages or thermoformed components resulting from the multilayer packaging films, thermoformable films, or recyclable films described herein, contain a product including a moisture content of greater than 30%.

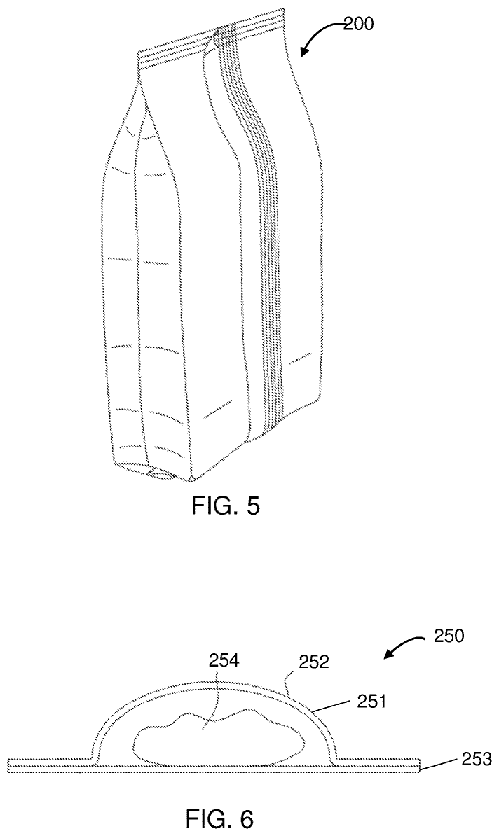

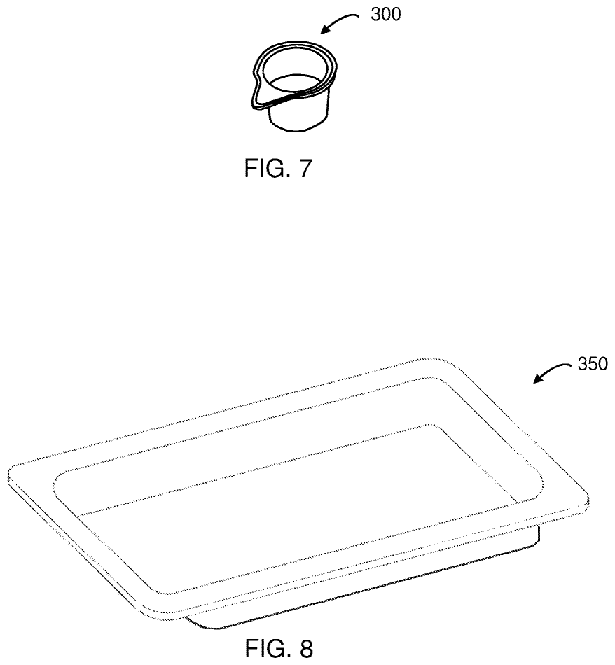

Non-limiting examples of packages that may be formed from the multilayer packaging films, packaging films, thermoformable films, or recyclable films disclosed herein are shown in FIGS. 5-8. Packages including little to no degree of thermoforming are shown in FIGS. 5-6. Other thermoformed components are shown in FIGS. 7-8. The packages or package components may contain a variety of products, food or non-food, that include a moisture content ranging from 0% to 100% or any range or combination of ranges therein. Packages or thermoformed components formed from the multilayer packaging films, packaging films, thermoformable films, and recyclable films disclosed herein are well suited to contain products that include a moisture content of greater than 30%, for example, 40%, 50%, 60%, 70%, 80%, 90%, 100%, or any moisture content therebetween. In an embodiment, packages or thermoformed components resulting from the multilayer packaging films, packaging films, thermoformable films, or recyclable films described herein, contain a product including a moisture content of greater than 30%.

A package 200 shown in FIG. 5 is a side-gusseted pouch that may be fabricated in a form-fill-seal process. Non-limiting package examples include a stand-up pouch, a pillow pouch, a retort pouch, a sachet, a brick bag, a flow wrap bag, a stick pack, and the like. A package 250 that is shown in FIG. 6 is a cold formed package that includes a base film 251 that includes the multilayer packaging films, packaging films, thermoformable films, or recyclable films disclosed herein. The package 250 further includes a lidding film 253 and the package 250 may be suited to contain a breakfast sandwich for example. The base film 251 includes a shallow, cold formed pocket 252. A product 254 is contained in package 250.

A thermoformed component 300 is shown in FIG. 7 as a liquid creamer cup. The liquid creamer cup may contain products having a moisture content of up to 100% (e.g., juices, gelatin snacks, liquid coffee creamer). The thermoformed component 300 may contain products with little to no moisture content, for example, coffee pod cups. Thermoformed components may be cup-shaped (e.g., relatively large draw depth with respect to component opening size) and may include volumes greater than the liquid creamer cup thermoformed component 300 shown in FIG. 8. For example, cup-shaped thermoformed components may contain products such as pudding or yogurt that include a moisture content in a range of about 75% to about 85%.

Thermoformed component 350 is shown in FIG. 8 as a tray. The tray may contain meat or poultry having a moisture content from about 55% to about 75%. Thermoformed components that are tray-shaped (e.g., relatively small draw depth with respect to component opening size) may include different volumes to contain different products, for example, snacks such as nuts having a moisture content from about 1% to about 20%, or cheese having a moisture content from about 30% to about 80%.

### Method of Making Multilayer Packaging Film or Packaging Film

Multilayer packaging films or packaging films can be made by suitable methods that may include extrusion coating a first film onto a first primer or a printed layer, for example. Other suitable methods for producing multilayer packaging films may include laminating the first film to the second film where various intermediate layers may be present, such as a first primer layer, a second primer layer, or a printed layer, with a laminating agent.

### Test Methods

Material Balance Evaluation: The Association of Plastic Recyclers (APR) in Document Number PET-P-00, dated Sep. 17, 2019, steps PET-P-01 through PET-P-04 (pages 3-12 of the protocol document).

Materials used for APR detergent wash solution were Triton X-100 nonionic surfactant and sodium hydroxide, NaOH, solution.

Interlayer adhesion bond strength: ASTM F904-98 (Reapproved 2003).

### EXAMPLES

### Example 1. Identification of Primer Configuration and Blends with Improved Initial Bond Strength and No Negative Impact on Delamination Time

Multilayer packaging films or packaging films according to the present disclosure were prepared in an experimental setting with the structures shown in Table 1 and tested for bond strength and delamination time. Structural components are listed in order from the first film to the second film. Table 1 structures were prepared as hand samples by applying the listed primer/primer blend(s) to a 2-mil corona treated PE sealant film as the second film using a #2 Meyer rod. The primer coated PE sealant film was then laminated to a 20-mil cast APET sheet as the first film using an office sheet laminator. Samples of the finally formed sheet were tested for bond strength after cooling down from the lamination heat. To test for delamination, eight pieces of 10 mm flake from each sample were placed into 80 mL of 1M NaOH solution at 85° C. in a small beaker with a magnetic stirrer at 600 rpm. Within Table 1, Primer 1 is an ionomeric water dispersible material of the ionomeric water dispersible sulfopolyester type, such as the EASTEK polymer dispersions developed by Eastman. Primer 2 is an a polyethylenimine (PEI)-based water dispersible material, such as those available from the Mica Corporation. Primer 3 is melamine-formaldehyde-based water dispersible material, such as those also available from the Mica Corporation. Primer 4 is a waterborne polyurethane adhesive system having an isocyanate-terminated component or an isocyanate-based adhesive coreactant. Primer 5 is an isocyanate-containing component.

TABLE 1
Film Structures and Results

| | | | Delamination |
|---|---|---|---|
| | | | Time |
| Sample | Structure | Bond Strength (g) | (min) |
| 1 | 20 mil APET/Primer | 1150 | 24 |
| | 1/2 mil PE sealant | | |
| 2 | 20 mil APET/Primer | 2125(sealant break) | 25 |
| | 1/Primer 2/2 mil PE | | |
| | sealant | | |
| 3 | 20 mil APET/Primer | 1750(delamination) | 21 |
| | 1:Primer 2/2 mil PE | | |
| | sealant | | |
| 4 | 20 mil APET/Primer | 1600 | 24 |
| | 1:Primer 3/2 mil PE | | |
| | sealant | | |
| 5 | 20 mil APET/Primer | 2050(sealant break) | 12 |
| | 1/Primer 4/2 mil PE | | |
| | sealant | | |
| 6 | 20 mil APET/Primer | 1750(delamination) | 23 |
| | 1:Primer 5/2 mil PE | | |
| | sealant | | |

Within the above Table 1, Sample 1 is considered control as it only contains a single layer of a single primer with no additional layers or blends. Sample 3 is a blend of Primer 1 to Primer 2 at a ratio of 1:1 by weight. Sample 4 is a blend of Primer 1 to Primer 3 at a ratio of 15:1 by weight. Sample 6 is a blend of Primer 1 to Primer 5 at a ratio of 100:1 by weight. The interlaminar bond strength between the first film and the second film was measured with the peak bond strength according to ASTM F 904-98 (Reapproved 2003) recorded and shown in Table 1. Examples were further subjected to a wash cycle within a beaker using a solution of 1M NaOH with continuous stirring. Examples were observed during this process and the time in minutes at which delamination occurred was recorded. From the results of Table 1 it is noted that the exemplary laminates using the various primer layers and primer blends provided a noticeable improvement in bond strength without a noticeable increase in delamination time.

### Example 2. Identification of Primer Configuration and Blends for Use with Additional Film Layer Types Including Print and Adhesive Layers and No Negative Impact on Delamination Time

Multilayer packaging films or packaging films according to the present disclosure were prepared in an experimental setting with the structures shown in Table 2 and tested for delamination. Example 2 builds upon the learnings of Example 1 wherein it is known that Primer 1 bonds well to discrete layers of polyurethane-based adhesives, polyurethane-based ink systems, as well as polyethylenimine (PEI)-based water dispersible materials, and melamine-formaldehyde-based water dispersible materials. The use of Primer 1 in these structures enables delamination of the PE portion of a laminate from the non-PE portion allowing for the collection of both materials and a reduction of the non-PE portion for post-consumer recycling in a polyethylene-based waste stream. Example Structural components are listed in order from the first film to the second film. Table 2 structures were prepared as hand samples by applying the listed primer/primer blend(s) to a 2-mil corona treated PE sealant film as the second film or to the first film as the primary web. The first film and the second film with the appropriate component/primer layers were then laminated using an office sheet laminator. Samples were tested for delamination after cooling down from the lamination heat. To test for delamination, eight pieces of 10 mm flake from each sample were placed into 80 mL of 1M NaOH solution or heated water at 85° C. in a small beaker with a magnetic stirrer at 600 rpm for 30 minutes. Within Table 2, Primer 1 is an ionomeric water dispersible material of the ionomeric water dispersible sulfopolyester type, such as the EASTEK polymer dispersions developed by Eastman. Primer 5 is an isocyanate-containing component. First film is either a 48 gauge oriented polyethylene terephthalate (OPET) film or a 75 gauge machine direction oriented polyethylene (MDOPE) film. Second film is a 2-mil corona treated PE sealant film. “Adh” as used within Table 2 refers to adhesive of the polyurethane-based type. “Print” as used within Table 2 refers to a printed layer of a polyurethane-based ink system.

TABLE 2
Film Structures and Results

| | | Number of Flakes |
|---|---|---|
| | | Delaminated after |
| Sample | Structure | 30 min |
| 7 | 48 ga OPET/Primer | 8 |
| | 1/Print/Adh/2 mil PE sealant | |
| 8 | 48 ga OPET/Primer | 8 |
| | 1/Adh/2 mil PE sealant | |
| 9 | 75 ga MDOPE/Primer | 8 |
| | 1/Adh/2 mil PE sealant | |
| 10 | 75 ga MDOPE/Printed/Primer | 8 |
| | 1/Adh/2 mil PE sealant | |
| 11 | 75 ga MDOPE/Printed/Primer | 6 |
| | 1 + Primer 5/Adh/2 mil | |
| | PE sealant | |
| 12 | 75 ga MDOPE/Primer 1 + | 8 |
| | Primer 5/2 mil PE sealant | |

As is seen from above Table 2, the exemplary laminates confirm that the selection of primer layers and blends in combination with polyurethane-based adhesives and ink systems enables delamination and allows for the separation of the PE portion of a laminate from the non-PE portion allowing for the collection of materials for post-consumer recycling.

### Example 3. Identification of Water-Soluble Dispersible Primer Configurations and Blends to Enable Deinking and Concurrent Delamination and Deinking

Multilayer packaging films or packaging films according to the present disclosure were prepared in an experimental setting as shown in Table 3 and tested for bond strength, delamination, and deinking. Structural components are listed in order from the first film to the second film. Table 3 structures were prepared as hand samples by applying the listed primer to a 2-mil corona treated PE sealant film. This 2-mil corona treated PE sealant film is used as both the first film and the second film. One of the primer coated PE sealant films was then coated with the selected ink and the films were laminated together using an office sheet laminator at a temperature of 140° C. Samples of the finally formed sheet were tested for bond strength after cooling down from the lamination heat. To test for delamination and deinking, pieces of 10 mm flake from each sample were placed into a solution of deionized water (DI) at a temperature of 85° C. in a small beaker with a magnetic stirrer at 600 rpm for a period of 30 minutes. Within Table 3, Primer 1 is an ionomeric water dispersible material of the ionomeric water dispersible sulfopolyester type, such as the EASTEK polymer dispersions developed by Eastman. Print 1 is a white colored polyurethane based inking system. Print 2 is a black colored polyurethane based inking system. Print 3 is a red colored polyurethane based inking system. Print 4 is a white colored nitrocellulose based inking system. Print 5 is a black colored nitrocellulose based inking system. Print 6 is a red colored nitrocellulose based inking system. Print layers were formed by printing colored inks (red and black) over the top of white ink layers.

TABLE 3
Film Structures and Results.

| | | Bond | | |
|---|---|---|---|---|
| | | Strength | | |
| Sample | Structure | (g/in) | Delaminated | Deinked |
| 1- | 2 mil PE sealant/Print/2 | 50 | No | No |
| Control | mil PE sealant | | | |
| 2 | 2 mil PE sealant/Primer | 95 | Yes | Partial |
| | 1/Print 1/Print 2/Primer | | | |
| | 1/2 mil PE sealant | | | |
| 3 | 2 mil PE sealant/Primer | 113 | Yes | Yes |
| | 1/Print 1/Print 3/Primer | | | |
| | 1/2 mil PE sealant | | | |
| 4 | 2 mil PE sealant/Primer | 95 | Yes | Partial |
| | 1/Print 4/Print 5/Primer | | | |
| | 1/2 mil PE sealant | | | |
| 5 | 2 mil PE sealant/Primer | 61 | Yes | Yes |
| | 1/Print 4/Print 6/Primer | | | |
| | 1/2 mil PE sealant | | | |

As is seen from above Table 3, the exemplary laminates confirm that the use of a primer layer in combination with polyurethane-based and nitrocellulose-based ink systems may enable for both delamination and deinking. The control sample 1 with no primer did not delaminate or deink despite having poor bond strength. An increase in bond strength and complete delamination was observed for all non-control samples, regardless of ink base chemistry. It is noted that samples containing red ink deink better than samples with black ink; the cause of this color discrepancy in deinking is not yet definitively known. One theory for the color discrepancy deinking is the ratio of pigment to resin. Generally, these results confirm that use of a primer layer of the type selected and similar types allows for the delamination and separation of ink components from the PE portion of a laminate. This may allow for the collection of inked materials for post-consumer recycling after deinking and delamination.

Further aspects of the present disclosure are provided by the subject matter of the following clauses.
Clause 1. A multilayer packaging film having a first surface and a second surface, the multilayer packaging film comprising: a first primer material comprising an ionomeric water dispersible material; a second optional primer material selected from the group comprising a melamine-formaldehyde-based water dispersible material, a polyethylenimine (PEI)-based water dispersible material, an isocyanate-containing component, and combinations thereof; a first film comprising a first polymer and having a first surface and a second surface; and a second film comprising a second polymer and having a first surface and a second surface; wherein the first primer material and the optional second primer material are positioned between the first film second surface and the second film first surface.
Clause 2. The multilayer packaging film of clause 1, further comprising a first primer layer comprising the first primer material.
Clause 3. The multilayer packaging film of clause 1, further comprising a first primer layer comprising a blend comprising the first primer material and the second primer material.
Clause 4. The multilayer packaging film of clause 2, further comprising a second primer layer comprising the second primer material.
Clause 5. The multilayer packaging film of any one of clauses 1-4, wherein the first polymer comprises a material selected from the group comprising polyester, polyamide, and polyethylene.
Clause 6. The multilayer packaging film of any one of clauses 1-5, wherein the second polymer comprises a material selected from the group comprising polyethylene and polyethylene copolymers.
Clause 7. The multilayer packaging film of any one of clauses 1-6, wherein the first film first surface comprises the multilayer packaging film first surface.
Clause 8. The multilayer packaging film of any one of clauses 1-7, wherein the second film second surface comprises the multilayer packaging film second surface.
Clause 9. The multilayer packaging film of any one of clauses 1-8, further comprising an average bond strength of 20 grams/25.4 millimeter (g/25.4 mm) or greater between the first film second surface and the second film first surface according to ASTM F 904-98 (Reapproved 2003).
Clause 10. The multilayer packaging film of any one of clauses 2-9, wherein the first primer layer comprises a thickness in a range of from greater than 0% to 20% of the thickness of the multilayer packaging film.
Clause 11. The multilayer packaging film of any one of clauses 4-10, wherein the second primer layer comprises a thickness in a range of from greater than 0% to 20% of the thickness of the multilayer packaging film.
Clause 12. The multilayer packaging film according to any one of clauses 1-11, wherein the average density of the second film is less than the average density of the first film.
Clause 13. The multilayer packaging film according to any one of clauses 2-12, wherein the first film is positioned adjacent to the first primer layer.
Clause 14. The multilayer packaging film according to any one of clauses 1-13, wherein the second film comprises a multilayer film.
Clause 15. The multilayer packaging film according to any one of clauses 1-14, wherein the second film is a coextruded film.
Clause 16. The multilayer packaging film according to any one of clauses 1-15, wherein the first film is an oriented film.
Clause 17. The multilayer packaging film according to any one of clauses 1-16, wherein the first polymer comprises a single polymer in a range of from 90% to 100% of the single polymer, by weight.
Clause 18. The multilayer packaging film according to any one of clauses 1-17, wherein the isocyanate-containing component is selected from the group comprising a polyurethane adhesive system having an isocyanate-terminated component, an isocyanate-based adhesive coreactant, and combinations thereof.
Clause 19. The multilayer packaging film according to any one of clauses 1-18, further comprising a printed layer comprising an ink selected from the group comprising a polyvinyl butyral (PVB)-based ink, a polyurethane (PU)-based ink, a nitrocellulose-based ink, and an acrylate-based ink, wherein the printed layer is positioned between the first film second surface and the second film first surface.
Clause 20. The multilayer packaging film according to clause 19, wherein the polyurethane (PU)-based ink comprises a polyester backbone.
Clause 21. A package comprising the multilayer packaging film according to any one of clauses 1-20.
Clause 22. A packaging film having a first surface and a second surface, the packaging film comprising: a first primer material comprising an ionomeric water dispersible material; a second primer material selected from the group comprising a melamine-formaldehyde-based water dispersible material, a polyethylenimine (PEI)-based water dispersible material, an isocyanate-containing component, and combinations thereof; a printed layer comprising an ink selected from the group comprising a polyvinyl butyral (PVB)-based ink, a polyurethane (PU)-based ink, a nitrocellulose-based ink, and an acrylate-based ink; and a first film comprising a first polymer and having a first surface and a second surface; wherein the first primer material and the second primer material are positioned between the first film second surface and the printed layer.
Clause 23. The packaging film of clause 22, further comprising a first primer layer comprising the first primer material.
Clause 24. The packaging film of clause 22, further comprising a first primer layer comprising a blend comprising the first primer material and the second primer material.
Clause 25. The packaging film of clause 23, further comprising a second primer layer comprising the second primer material.

Each and every document cited in this present application, including any cross referenced, is incorporated in this present application in its entirety by this reference, unless expressly excluded or otherwise limited. The citation of any document is not an admission that it is prior art with respect to any embodiment disclosed in this present application or that it alone, or in any combination with any other reference or references, teaches, suggests, or discloses any such embodiment. Further, to the extent that any meaning or definition of a term in this present application conflicts with any meaning or definition of the same term in a document incorporated by reference, the meaning or definition assigned to that term in this present application governs.

Unless otherwise indicated, all numbers expressing sizes, amounts, ranges, limits, and physical and other properties used in the present application are to be understood as being preceded in all instances by the term “about”. Accordingly, unless expressly indicated to the contrary, the numerical parameters set forth in the present application are approximations that can vary depending on the desired properties sought to be obtained by a person of ordinary skill in the art without undue experimentation using the teachings disclosed in the present application.

Spatially related terms, including but not limited to, “lower”, “upper”, “beneath”, “below”, “above”, “bottom” and “top”, if used in the present application, are used for ease of description to describe spatial relationships of an element(s) to another. Such spatially related terms encompass different orientations of the device in use or operation, in addition to the particular orientations depicted in the figures and described in the present application. For example, if an object depicted in the drawings is turned over or flipped over, elements previously described as below, or beneath other elements would then be above those other elements.

The description, examples, embodiments, and drawings disclosed are illustrative only and should not be interpreted as limiting. The present invention includes the description, examples, embodiments, and drawings disclosed; but it is not limited to such description, examples, embodiments, or drawings. As briefly described above, the reader should assume that features of one disclosed embodiment can also be applied to all other disclosed embodiments, unless expressly indicated to the contrary. Modifications and other embodiments will be apparent to a person of ordinary skill in the packaging arts, and all such modifications and other embodiments are intended and deemed to be within the scope of the present invention.

1. A multilayer packaging film having a first surface and a second surface, the multilayer packaging film comprising:
a first primer material comprising an ionomeric water dispersible material;
an optional second primer material selected from the group comprising a melamine-formaldehyde-based water dispersible material, a polyethylenimine (PEI)-based water dispersible material, an isocyanate-containing component, and combinations thereof;
a first film comprising a first polymer and having a first surface and a second surface; and
a second film comprising a second polymer and having a first surface and a second surface;
wherein the first primer material and the optional second primer material are positioned between the first film second surface and the second film first surface.

2. The multilayer packaging film of claim 1, further comprising a first primer layer comprising only the first primer material.

3. The multilayer packaging film of claim 1, further comprising a first primer layer comprising a blend comprising the first primer material and the second primer material.

4. The multilayer packaging film of claim 2, further comprising a second primer layer comprising only the second primer material.

5. The multilayer packaging film of claim 1, wherein the first polymer comprises a material selected from the group comprising polyester, polyamide, polypropylene, polystyrene, and polyethylene.

6. The multilayer packaging film of claim 1, wherein the second polymer comprises a material selected from the group comprising polypropylene, polyethylene and polyethylene copolymers.

7. The multilayer packaging film of claim 1, wherein the first film first surface comprises the multilayer packaging film first surface.

8. The multilayer packaging film of claim 1, wherein the second film second surface comprises the multilayer packaging film second surface.

9. The multilayer packaging film of claim 1, further comprising an average bond strength of 20 grams/25.4 millimeter (g/25.4 mm) or greater between the first film second surface and the second film first surface according to ASTM F 904-98 (Reapproved 2003).

10. The multilayer packaging film of claim 1, wherein the first primer layer comprises a thickness in a range of from greater than 0% to 20% of the thickness of the multilayer packaging film.

11. The multilayer packaging film of claim 1, wherein the second primer layer comprises a thickness in a range of from greater than 0% to 20% of the thickness of the multilayer packaging film.

12. The multilayer packaging film according to claim 1, wherein the average density of the second film is less than the average density of the first film.

13. The multilayer packaging film according to claim 2, wherein the first film is positioned adjacent to the first primer layer.

14. The multilayer packaging film according to claim 1, wherein the second film comprises a multilayer film.

15. The multilayer packaging film according to claim 1, wherein the second film is a coextruded film.

16. The multilayer packaging film according to claim 1, wherein the first film is an oriented film.

17. The multilayer packaging film according to claim 1, wherein the first polymer comprises a single polymer in a range of from 90% to 100% of the single polymer, by weight.

18. The multilayer packaging film according to claim 1, wherein the isocyanate-containing component is selected from the group comprising a polyurethane adhesive system having an isocyanate-terminated component, an isocyanate-based adhesive coreactant, and combinations thereof.

19. The multilayer packaging film according to claim 1, further comprising a printed layer comprising an ink selected from the group comprising a polyvinyl butyral (PVB)-based ink, a polyurethane (PU)-based ink, a nitrocellulose-based ink, a polyamide-based ink, a polyester-based ink, and an acrylate-based ink, wherein the printed layer is positioned between the first film second surface and the second film first surface.

20. The multilayer packaging film according to claim 19, wherein the polyurethane (PU)-based ink comprises a polyester backbone.

21. A package comprising the multilayer packaging film according to claim 1.

22. A packaging film having a first surface and a second surface, the packaging film comprising:
a first primer material comprising an ionomeric water dispersible material;
an optional second primer material selected from the group comprising a melamine-formaldehyde-based water dispersible material, a polyethylenimine (PEI)-based water dispersible material, an isocyanate-containing component, and combinations thereof;
a printed layer comprising an ink selected from the group comprising a polyvinyl butyral (PVB)-based ink, a polyurethane (PU)-based ink, a nitrocellulose-based ink, and an acrylate-based ink; and
a first film comprising a first polymer and having a first surface and a second surface;
wherein the first primer material and the optional second primer material are positioned between the first film second surface and the printed layer.

23. The packaging film of claim 22, further comprising a first primer layer comprising the first primer material.

24. The packaging film of claim 22, further comprising a first primer layer comprising a blend comprising the first primer material and the second primer material.

25. The packaging film of claim 23, further comprising a second primer layer comprising the second primer material.
